(19) United States
(12) Patent Application Publication
(10) Pub. No.: US 2006/0259845 A1
(43) Pub. Date: Nov. 16, 2006

(54) Method and apparatus for acknowledging a bitwise data chunk in wireline and wireless communication systems

(76) Inventor: Seung-Min Baek, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/410,286

(22) Filed: Apr. 25, 2006

(30) Foreign Application Priority Data
Apr. 25, 2005 (KR) 2005-33995

(51) Int. Cl. H04L 1/18; G08C 25/02

(52) U.S. Cl. 714/748

(57) ABSTRACT

A method and apparatus for acknowledging a bitwise data chunk in wireline and wireless communication systems. Data of at least one chunk is received from a sending node. Bitwise acknowledgement (ACK) information for each chunk is generated after a cumulative ACK. A predetermined message is transmitted in which the information is recorded, in a word having predetermined bits, in reverse order from a least significant bit. Lost chunk data is again received. The method and apparatus are useful in a wireless environment in which loss occurs frequently and can improve communication performance by applying an intuitive Selective Acknowledgement (SACK) format and a Selective Bitwise Chunk Acknowledgement (SBCA) for efficient bit use. The method and apparatus can securely transfer a signal of a public telephone network on a network through a multi-homing function and a multi-streaming function.

### CROSS-REFERENCE TO RELATED APPLICATION

This application claims the benefit under 35 U.S.C. § 119(a) to a Korean Patent Application filed in the Korean Intellectual Property Office on Apr. 25, 2005 and assigned Serial No. 2005-33995, the entire disclosure of which is hereby incorporated by reference.

### BACKGROUND OF THE INVENTION

1. Field of the Invention

The present invention generally relates to a method and apparatus for acknowledging a bitwise data chunk in wireline and wireless communication systems. More particularly, the present invention relates to a method and apparatus for acknowledging a bitwise data chunk on the basis of a cost-effective and intuitive Selective Acknowledgement (SACK) chunk format within a Stream Control Transmission Protocol (SCTP) header.

2. Description of the Related Art

Stream Control Transmission Protocol (SCTP) has been developed for convergence between telephone and computer networks by the SIGnaling TRANsport (SIGTRAN) working group of the Internet Engineering Task Force (IETE). The SCTP is a transport layer protocol present between communication nodes such as Transmission Control Protocol (TCP) and supplements the TCP. Accordingly, many SCTP elements are based on the TCP. On the other hand, the SCTP is based on multi-homing, multi-streaming, and a message-oriented error control algorithm rather than a byte-oriented error control algorithm.

Moreover, the SCTP is receiving attention as a next-generation transmission protocol useful for a mobile Internet Protocol (IP) field requiring high performance and flexibility in a data transmission, an application environment for transmitting multiple objects as in multimedia or Hyper Text Transfer Protocol (HTTP), authentication for high reliability and security, and military communication equipment. In the following, retransmission algorithms of the TCP and SCTP are compared with reference to FIGS. 1 and 2.

FIG. 1 illustrates a retransmission algorithm of the conventional TCP.

Referring to FIG. 1, a sending node divides a data stream #1 to be currently transmitted into data packets A, B, C, and D among data streams #1, #2, and #3 present in a transmission standby state and then transmits the data packets A, B, C, and D using the TCP retransmission algorithm. The data packets A, B, C, and D are included in a header information field 100 in the form of a payload, and are sequentially transmitted from the sending node to a receiving node. When the data packet C is lost during the transmission, a data packet with a maximum size including data of the data packet C is retransmitted in the form of a byte-based Maximum Transfer Unit (MTU).

FIG. 2 illustrates a retransmission algorithm of the conventional SCTP.

Referring to FIG. 2, data streams #1, #2, and #3 are present in a transmission standby state in a sending node using the SCTP retransmission algorithm. The data stream #1 is divided and transmitted in chunks A, B, C, and so on. The data stream #2 is divided and transmitted in chunks O, P, Q, and so on. The data stream #3 is divided and transmitted in chunks W, X, Y, and so on. However, when packets 200, 210, 220, and 230 are constructed and transmitted in the SCTP different from the TCP, for example, one packet sequentially includes the data chunk A of the stream #1, data chunk O of the stream #2, and data chunk W of the stream #3. Similarly, the packet 210 or 220 includes only chunk B or sequentially includes chunks P and X. Another packet is transmitted which sequentially includes B, P, and X. When the data packets 200 and 210 are lost during the transmission, packets 240 and 250 are constructed and transmitted which include the same as the lost chunks.

FIG. 3 illustrates a format of a conventional SCTP packet.

Referring to FIG. 3, the SCTP packet 301 includes a common header 305 and n chunks 303. The common header 305 includes “Source Port Number”, “Destination Port Number”, “Verification Tag”, and “Checksum” fields. The chunks 303 are a general chunk 307, data chunk 309, and Selective Acknowledgement (SACK) chunk 311. The general chunk 307 includes “Type”, “Flags”, “Length”, and “Chunk Value” fields. The data chunk 309 includes “Type”, “Reserved”, “Length”, “Transmission Sequence Number (TSN)”, “Stream Identifier”, “Stream Sequence Number”, “Payload Protocol Identifier”, and “User Data” fields. The SACK chunk 311 includes “Type”, “Flags”, “Length”, “Cumulative TNS Ack”, “Advertised Receiver Window Credit”, “Number of Gap Ack Blocks” and “Number of Duplicated TSNs” fields, and their values. The functions of the fields within the SACK chunk 311 will be described below with reference to FIGS. 4A and 4B.

FIGS. 4A and 4B illustrate sending and receiving nodes for performing SCTP communication and a conventional SACK format based on the SCTP.

Referring to FIG. 4A, the sending node 401 divides a data stream into chunks #1 to #16, and then transmits chunks #1 to #16 to the receiving node 403. At this time, chunks #1, #2, #3, #7, #8, #9, #13, #14, and #16 are transmitted to the receiving node 403 without loss, whereas chunks #4, #5, #6, #10, #11, #12, and #15 are lost. Upon receiving an SCTP packet, the receiving node 403 generates a SACK chunk and then transmits the generated SACK chunk to the sending node 401. Referring to FIG. 4B, “Cumulative TSN Ack”=3 and the received chunks are chunks #1, #2, #3, #7, #8, #9, #13, #14, and #16. Because the number of lost blocks are 3, “Number of Gap Blocks”=3. Also, because chunks #7, #8, and #9 corresponding to the first block are 4th, 5th, and 6th chunks after chunks #1, #2, and #3 are received, “Ack Block #1 Start”=4 and “Ack Block #1 End”=6. Because chunks #13 and #14 corresponding to the second block are 10th and 11th chunks after chunks #1, #2, and #3 are received, “Ack Block #1 Start”=10 and “Ack Block #1 End”=11. Also, because chunk #16 corresponding to the third block is a 13th chunk after chunks #1, #2, and #3 are received, “Ack Block #1 Start”=13 and “Ack Block #1 End”=13.

Similar to the TCP SACK, the conventional SCTP SACK is used to recover all lost chunks within a Round Trip Time (RTT). The sending node 401 retransmits data chunks mapped to lost TSN values with received SACK chunk information. A plurality of data chunks can be transmitted in an MTU range, but a recovery unit is a chunk. As a result, the sending node 401 knows information about a data chunk mapped to each TSN in order to retransmit an associated chunk. On the other hand, when loss occurs in the case of the TCP SACK, bytes mapped to a sequence number block are combined and retransmitted in an MTU size. Thus, a retransmission packet is independent of a lost packet in the case of the TCP SACK.

FIG. 4B illustrates an example of the SCTP SACK. Conventionally, an SCTP SACK chunk has the format and field definition similar to that of the TCP SACK chunk. In the SCTP, which is different from the TCP, a message-oriented error control algorithm includes a possibility that a current SCTP SACK chunk format may not be suitable for error control. That is, the conventional TCP SACK format indicates a sequence number block for successfully received bytes in two words, but the SCTP SACK chunk indicates a TSN block of successfully received messages. The TSN is a sequence number allocated to each data chunk. The receiving node 403 indicates that data chunks #1, #2, #3, #7, #8, #9, #13, #14, and #16 have been successfully received and “Cumulative ACK Number”=3 in the SACK format. Because successfully received chunk blocks are three blocks which includes the block of chunks #7, #8, and #9, the block of chunks #13 and #14, and the block of the chunk # 16 after a cumulative ACK, “Number of GAP Ack Blocks”=3 in the SACK format. The start and end of each block are expressed by a 16-bit offset value from the cumulative ACK. Therefore, the blocks can be expressed by pairs of (4, 6), (10, 11), and (13, 13). Upon receiving the SCTP SACK chunk, the sending node 401 can know that the lost chunks are chunks #4, #5, #6, #10, #11, #12, and #15. Because a “Number of Duplicated TSNs” field does not directly relate to the present invention, its description is omitted for clarity and conciseness.

It can be estimated that bits may be wasted when the chunk blocks are expressed in the conventional SCTP SACK. For example, when one of two consecutive chunks is lost, one block expresses one chunk. The conventional SCTP SACK format is efficient when the length of a chunk block is long, regardless of loss or success. In the case of a wireless link with low reliability, there is a problem in that packet loss may occur frequently.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and apparatus for acknowledging a bitwise data chunk by exploiting a specialized Selective Acknowledgement (SACK) chunk format in Stream Control Transmission Protocol (SCTP) for performing message-oriented error control different from Transmission Control Protocol (TCP).

In accordance with an aspect of exemplary embodiments of the present invention, there is provided a method for acknowledging a bitwise data chunk in wireline and wireless communication systems, in which data of at least one chunk is received from a sending node, bitwise acknowledgement (ACK) information is generated for each chunk after a cumulative ACK, a predetermined message is transmitted in which the information is recorded, in a word having predetermined bits, in reverse order from a least significant bit, and lost chunk data is received again.

In accordance with another aspect of exemplary embodiments of the present invention, there is provided a method for acknowledging a bitwise data chunk in wireline and wireless networks, in which data of at least one chunk is transmitted to a receiving node, a predetermined message is received, from the receiving node, in which bitwise acknowledgement (ACK) information is recorded, in a word having predetermined bits, in reverse order from a least significant bit, and the information is analyzed and lost chunk data is retransmitted.

In accordance with yet another aspect of exemplary embodiments of the present invention, there is provided an apparatus of a sending/receiving node for acknowledging a bitwise data chunk in wireline and wireless networks, in which a controller controls all components; an acknowledgement (ACK) information generator generates bitwise ACK information according to an instruction or determination of the controller, an ACK information analyzer receives and analyzes the bitwise ACK information and transfers an analysis result to the controller; a message generator generates a predetermined message according to the instruction or determination of the controller and transfers the generated message to a message transceiver, the message transceiver transmits and receives a predetermined message between sending and receiving nodes, and a data transceiver transmits and receives a data chunk controlled according to the bitwise ACK information.

### BRIEF DESCRIPTION OF THE DRAWINGS

The above and other objects, features, and advantages of certain exemplary embodiments of the present invention will be more apparent from the following detailed description taken in conjunction with the accompanying drawings, in which:

FIG. 1 illustrates a retransmission algorithm of a conventional Transmission Control Protocol (TCP);

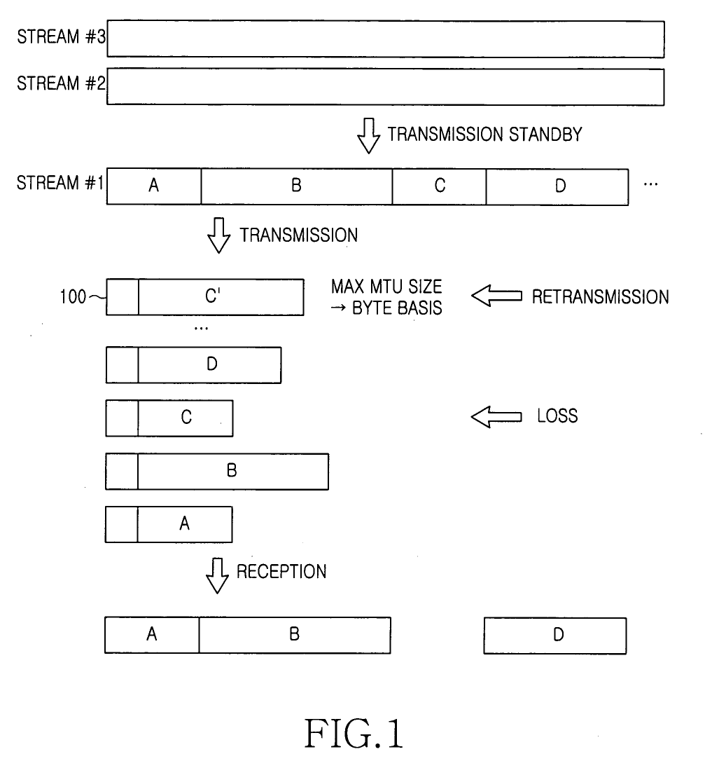

FIG. 2 illustrates a retransmission algorithm of a conventional Stream Control Transmission Protocol (SCTP);

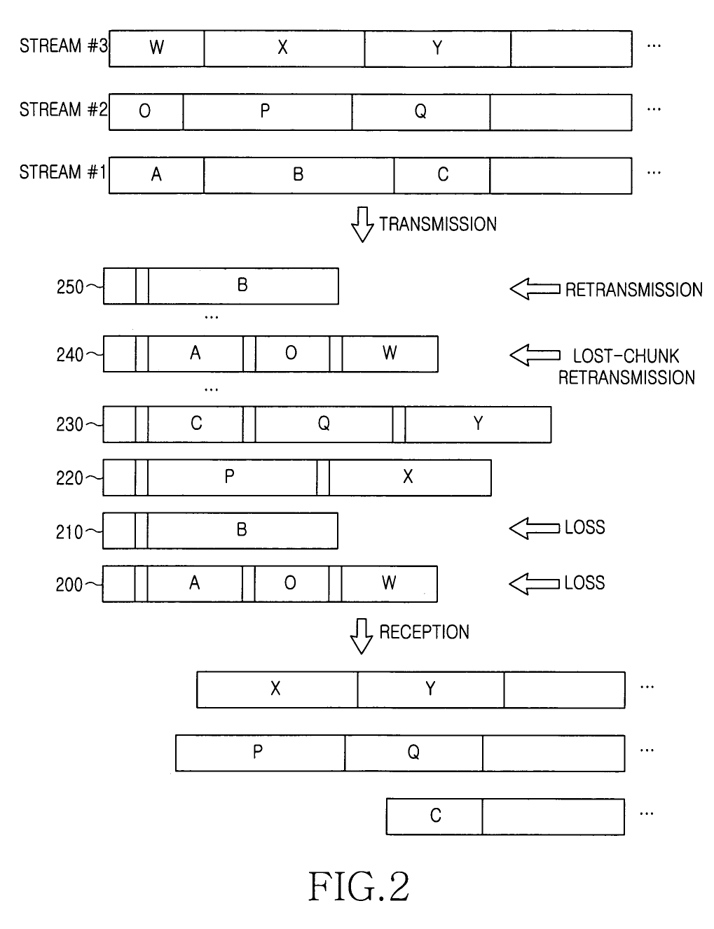

FIG. 3 illustrates a format of a conventional SCTP packet;

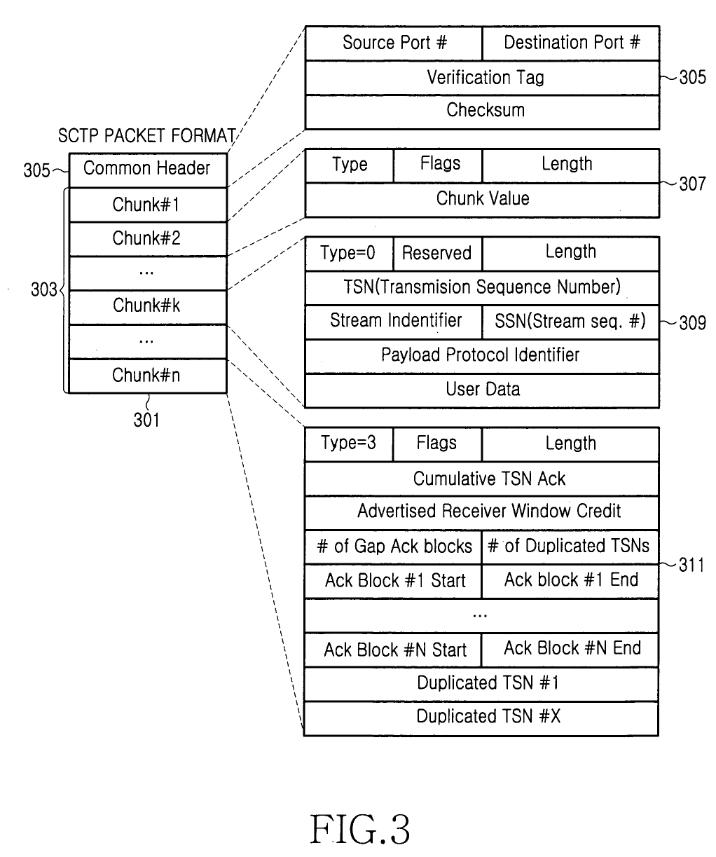

FIGS. 4A and 4B illustrate sending and receiving nodes for performing SCTP communication and a conventional Selective Acknowledgement (SACK) format based on the SCTP;

FIG. 5 illustrates a procedure for receiving data chunks between the sending and receiving nodes in accordance with an exemplary embodiment of the present invention;

FIG. 6 illustrates an example of an SCTP SACK chunk format in accordance with an exemplary embodiment of the present invention; and

FIG. 7 is a block diagram illustrating a device of the sending/receiving node.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

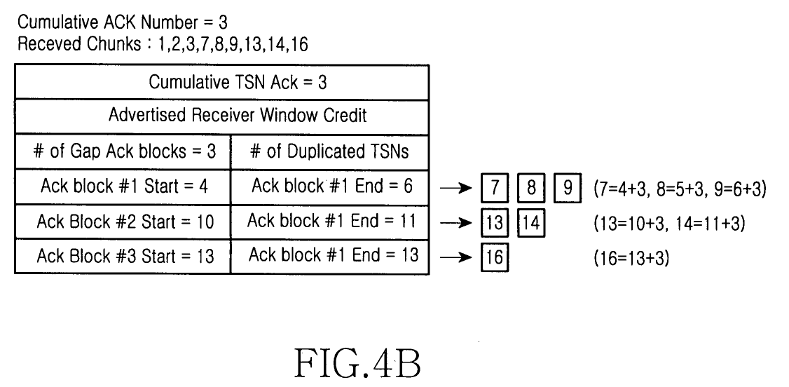

In certain exemplary embodiments of the present invention, because a Stream Control Transmission Protocol (SCTP)-based sending node basically maintains chunk information mapped to each Transmission Sequence Number (TSN), SCTP Selective Acknowledgement (SACK) information does not need to be block information as in the Transmission Control Protocol (TCP) SACK. The SCTP-based sending node can transmit cost-effective and intuitive ACK information by mapping one bit to one chunk. For a Selective Bitwise Chunk Acknowledgement (SBCA), an ACK message is generated in a word in which each bit indicates one data chunk. The ACK word can abstractly express a receiving node window. Next, the above-described SBCA will be described in detail with reference to FIGS. 5 to 7.

FIG. 5 illustrates a procedure for receiving data chunks between sending and receiving nodes in accordance with an exemplary embodiment of the present invention.

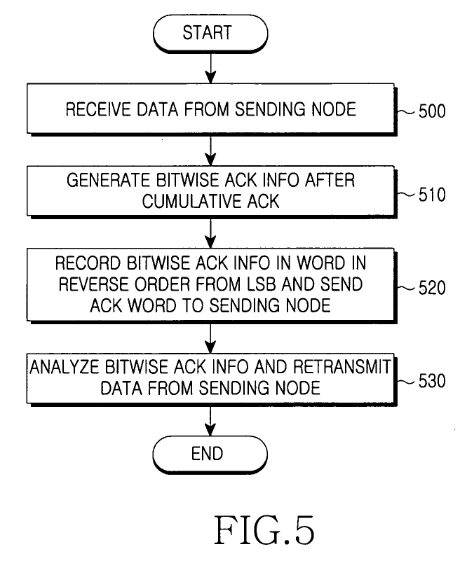

Referring to FIG. 5, the receiving node receives data chunks from the sending node in step 500. The receiving node generates bitwise ACK information for each chunk after a cumulative ACK in step 510. The bitwise ACK information for each chunk will be described below in detail with reference to FIG. 6. The receiving node transmits, to the sending node, a predetermined message in which the bitwise ACK information is recoded in a word in reverse order from the Least Significant Bit (LSB) in step 520. The sending node analyzes the bitwise ACK information of the received message and then retransmits data to the receiving node in step 530.

FIG. 6 illustrates an example of an SCTP SACK chunk format in accordance with an exemplary embodiment of the present invention.

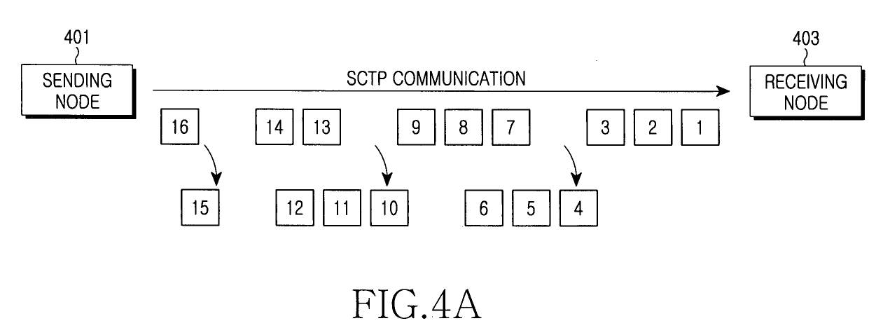

For example, FIG. 6 illustrates the SACK chunk format according to an exemplary embodiment of the present invention within a SCTP header generated from the receiving node under the same conditions as those of FIG. 4A. In the example of FIG. 6, “Cumulative ACK Number”=3, chunks received in the receiving node are chunks #1, #2, #3, #7, #8, #9, #13, #14, and #16, and lost chunks are chunks #4, #5, #6, #10, #11, #12, and #15 as in the conditions of FIG. 4A. The chunks received in the receiving node are indicated by “1”, and the lost chunks are indicated by “0”. The example of the SACK chunk format defined according to the above-described conditions is as follows. That is, the SACK format of the present invention according to the conditions of FIG. 4A includes a “Cumulative TSN Ack Number” field 600 with a value of “3”, an “Advertised Receiver Window Credit” field 610 for indicating a dedicated buffer space, a “Number of Words” field 620 with a value of “1”, a “Granularity” field 630 with a value of “1”, a “Number of Duplicated TSNs” field 640, and a bitwise ACK information field 650 with a value of “0 . . . 01011000111000”.

As described above, the receiving node can generate the bitwise ACK information for each chunk after the cumulative ACK. At this time, “0” indicates loss, and “1” indicates success. Thirteen bits are required for ACK information for the chunks #4 to #16, and has a value of “0001110001101”. The receiving node records the bitwise ACK information in a 32-bit word in reverse order from the LSB, fills the remaining bits with 0's, and transmits the ACK word to the sending node. If a receiving node window size is greater than 32 chunks, an additional ACK word is generated. The “Number of Words” field 620 indicates the number of ACK words.

The sending node can easily compute an effective ACK bit range using an ACK word value. Through a right-shift operation, ACK information of each chunk can be used in a one bit unit. The present invention can efficiently generate ACK information also in a network link in which loss frequently occurs, which is different from the conventional SCTP SACK. However, when the length of a lost or ACK chunk block is long, bits may be wasted. In this an exemplary implementation, the waste can be reduced by adjusting the number of chunks per bit. The “Granularity” field 630 indicates the number of chunks per bit. For either the loss case or the reception success case, the number of chunks per bit can be set. For example, a 1:1 ratio can be set. Through a comparison between FIGS. 6 and 4B, it can be found that 8 bytes can be saved.

When the length of a successful chunk block is long, the sending node can sufficiently receive ACK information even when a size of ACK information of the receiving node is small. On the other hand, if the length of a lost chunk block is long, it means that special control is to be applied for congestion or flow control. A chunk ACK time-out value limits an increase in the length of the lost chunk block. As a result, it is preferred that the “Granularity” value is set to “1”.

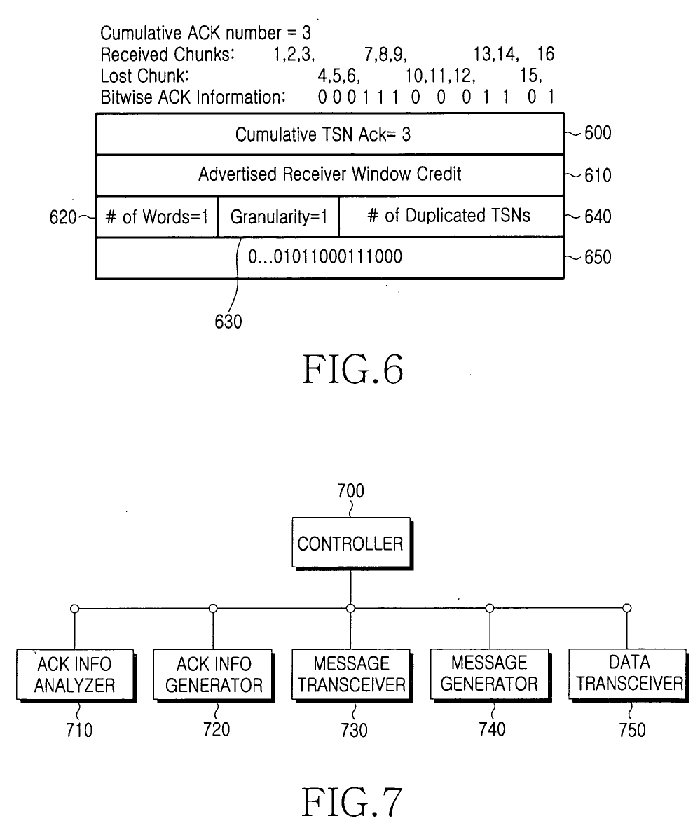

FIG. 7 is a block diagram illustrating a device of the sending/receiving node.

Referring to FIG. 7, the device of the sending/receiving node is provided with an ACK information analyzer 710, ACK information generator 720, message transceiver 730, message generator 740, data transceiver 750, and controller 700.

When the device of the present invention performs an operation of the sending node, the ACK information analyzer 710 receives and analyzes the SCTP SACK information or bitwise ACK information defined in FIG. 6, and transfers an analysis result to the controller 700. When the device according to an exemplary embodiment of the present invention performs an operation of the receiving node, the ACK information generator 720 generates the SCTP SACK information or bitwise ACK information defined in FIG. 6 according to an instruction or determination of the controller 700.

The message transceiver 730 transmits and receives a predetermined SCTP message between the sending and receiving nodes according to the instruction or determination of the controller 700. The message generator 740 generates the message according to the instruction or determination of the controller 700 and then transfers the generated message to the message transceiver 730. The data transceiver 750 transmits and receives data controlled according to the predetermined SCTP message. The controller 700 controls all the components of the device of the sending/receiving node.

Accordingly, the components as described with reference to FIG. 7 can be implemented with the controller 700.

As is apparent from the above description, exemplary embodiments of the present invention have the following effects.

Certain exemplary implementations of the present invention may be useful in a wireless environment in which loss occurs frequently and can improve communication performance by applying an intuitive SACK format and an SBCA for efficient bit use.

Moreover, certain exemplary implementations of the present invention can securely transfer a signal of a public telephone network on a network through a multi-homing function and a multi-streaming function.

While the invention has been shown and described with reference to certain exemplary embodiments thereof, it will be understood by those skilled in the art that various changes in form and details may be made therein without departing from the spirit and scope of the invention as defined the by appended claims.

What is claimed is:

1. A method for acknowledging a bitwise data chunk in wireline and wireless communication systems, the method comprising:
receiving data of at least one chunk from a sending node;
generating bitwise acknowledgement (ACK) information for each chunk after a cumulative ACK;
transmitting a message comprising information recorded, in a word comprising bits, in reverse order from a least significant bit; and
receiving lost chunk data.

2. The method of claim 1, wherein the bitwise ACK information comprises at least one of “0” which indicates loss and “1” which indicates success for each chunk.

3. The method of claim 1, wherein the message comprises a granularity value set according to at least one of loss and success.

4. The method of claim 1, wherein the bits remaining comprise O's after the information is recorded, in the word comprising the bits, in the reverse order from the least significant bit.

5. The method of claim 1, wherein when a number of chunks is more than a value of the bits, an additional word is generated.

6. A method for acknowledging a bitwise data chunk in wireline and wireless networks, the method comprising:
transmitting data of at least one chunk to a receiving node;
receiving, from the receiving node, a message comprising bitwise acknowledgement (ACK) information recorded, in a word comprising bits, in reverse order from a least significant bit; and
analyzing the information and retransmitting lost chunk data.

7. The method of claim 6, wherein the bitwise ACK information comprises at least one of “0” which indicates loss and “1” which indicates success for each chunk.

8. The method of claim 6, wherein the message comprises a granularity value set according to at least one of loss or success.

9. The method of claim 6, wherein the bits remaining comprise O's after the information is recorded, in the word having the bits, in the reverse order from the least significant bit.

10. The method of claim 6, wherein when a number of chunks is more than a value of the bits, an additional word is generated.

11. An apparatus of a sending/receiving node for acknowledging a bitwise data chunk in wireline and wireless networks, the apparatus comprising:
a controller for controlling components of the apparatus;
an acknowledgement (ACK) information generator for generating bitwise ACK information according to at least one of an instruction and determination of the controller;
an ACK information analyzer for receiving and analyzing the bitwise ACK information and transferring an analysis result to the controller;
a message generator for generating a message according to at least one of the instruction and determination of the controller, and transferring the generated message to a message transceiver;
the message transceiver for at least one of transmitting and receiving a message between sending and receiving nodes; and
a data transceiver for at least one of transmitting and receiving a data chunk controlled according to the bitwise ACK information.

12. The apparatus of claim 11, wherein the bitwise ACK information comprises at least one of “0” which indicates loss and “1” which indicates success for each chunk.

13. The apparatus of claim 11, wherein the message comprises a granularity value set according to at least one of loss and success.

14. The apparatus of claim 11, wherein the bits remaining comprise O's after the information is recorded, in a word having bits, in reverse order from a least significant bit.

15. The apparatus of claim 11, wherein when a number of chunks is more than a bit value, an additional word is generated.
